(19) United States
(12) Patent Application Publication
(10) Pub. No.: US 2024/0086932 A1
(43) Pub. Date: Mar. 14, 2024

(54) COMPUTING ARCHITECTURE FOR TRANSACTION AUTHORIZATION AND MEDIUMS AND METHODS FOR THE SAME

(71) Applicant: PERPAY INC., Philadelphia, PA (US)

(72) Inventors: Anthony C. Dimarco, Philadelphia, PA (US); James Morgan Salmon, Philadelphia, PA (US); Arik Misler, Philadelphia, PA (US)

(21) Appl. No.: 18/463,880

(22) Filed: Sep. 8, 2023

Related U.S. Application Data
(60) Provisional application No. 63/406,118, filed on Sep. 13, 2022.

(51) Int. Cl. G06Q 20/40; G06Q 20/34

(52) U.S. Cl. CPC G06Q 20/409; G06Q 20/341; G06Q 20/405

(57) ABSTRACT

Exemplary embodiments pertain to a computer architecture for supporting transactions through a transaction card, as well as methods, mediums, and interfaces for use with the architecture. According to one embodiment, a request to perform a transaction for an identified amount between a user and a merchant server may be received at a provider server associated with a transaction card issued to the user. The provider server may identify a card value store and a primary value store associated with the user. The provider server may determine whether the transaction card is in an active state based on an occurrence of an automatic transfer between an employer institution and the primary value store in a most-recent predetermined time interval. If the card is active, the provider server may transmit a control signal to the merchant server, the control signal configured to authorize the transaction on behalf of the user.

### CROSS-REFERENCE TO RELATED APPLICATIONS

This application claims the benefit of pending U.S. Provisional Patent Application No. 63/406,118, filed Sep. 13, 2022, entitled “COMPUTING ARCHITECTURE FOR TRANSACTION AUTHORIZATION AND MEDIUMS AND METHODS FOR THE SAME” the entirety of which application is incorporated by reference herein.

### BACKGROUND

The embodiments described herein relate to a computer architecture for supporting transactions through transaction cards. Conventional transaction cards employ a relatively straightforward approach to authorizing transactions generally based on whether the transaction would cause the user to exceed a predetermined maximum limit.

Although fairly simple to implement, this approach suffers from a number of drawbacks. For example, the maximum limit tends to be a relatively inexact threshold, and there is no guarantee that a user will have sufficient funds to pay for the transaction, even if they remain under the predetermined maximum limit. Furthermore, users with limited credit history may be assigned an unnecessarily low maximum limit and may not have a way to increase it, despite having the ability to afford larger transactions.

The embodiments described herein employ a more sophisticated approach to transaction authorization which involves increased coordination among parties in a computing architecture.

### BRIEF SUMMARY

Exemplary embodiments relate to a computer architecture for supporting transactions with a transaction card, such as a credit card, and to mediums, methods, and interfaces for use by the computer architecture.

In one embodiment, a computer-implemented method includes receiving, at a provider server associated with a provider of a transaction card to a user, a request to perform a transaction for an identified amount between the user and a merchant server. For example, the transaction card may be a credit card, and the transaction may be a credit or debit transaction between the user and a merchant associated with the merchant server.

At the provider server, a card value store associated with the transaction card of the user may be identified. The card value store may be associated with a primary value store distinct from the card value store and maintained by the provider server. For example, the provider server may maintain (e.g., in a database) records for each user of the provider. The records may include information regarding a credit account (the credit value store) and a related but separate and distinct primary value store (e.g., a customer account) maintained by the provider on behalf of the user.

The transaction may be authorized when the card is active, and not authorized when the card is inactive. The card may be placed in an active state when certain conditions apply. In particular, the card may be placed in the active state if an automatic transfer of a predetermined threshold amount occurred in a most-recent predetermined time interval, the automatic transfer causing the predetermined threshold amount to be transferred to the primary value store from a third-party institution associated with the user. For example, the third-party institution may be the user's employer, or a financial institution associated with the user's employer. In some embodiments, the automatic transfer may be an automatic payroll direct deposit into the primary value store at intervals defined by the user's pay periods with their employer. If the automatic transfer from the third-party institution does not occur as expected, then the card may be placed in the inactive state.

A control signal may be transmitted to the merchant server. The control signal may be configured to authorize the transaction on behalf of the user when the transaction card is in the active state, or deny the transaction on behalf of the user when the transaction card is in the inactive state.

Embodiments may, in some cases, make use of a maximum limit for transactions. However, by combining the maximum limit with placing the card in an active or inactive state as noted above, several of the limitations of conventional techniques can be overcome. For example, when the card is in an active state (e.g., because direct deposit withdrawals have been approved from the third-party institution), it is more likely that the user will be able to make the required payments for the transaction. Moreover, the user need not have a long credit history because the automatic transfers provide a degree of assurance that the user will make payments. Still further, as the user continues to authorize automatic transfers and makes required payments, the user can build their credit history and qualify for increased credit opportunities.

The claimed embodiments also provide technical improvements to transaction processing. By setting the card as active or inactive based on the automatic transfer history, transaction processing can occur more quickly and efficiently. Effectively, the work of determining whether a purchase should be approved is handled before the transaction request is received by setting the card as active/inactive at the predetermined evaluation intervals. If the card is active, the transaction can be approved quickly (and vice versa if the card is inactive), without the need for excessive processing at the time of the transaction. Furthermore, the initial setup process can be streamlined, since it may not be necessary to transmit and receive network traffic to perform credit checks when establishing a new user account—instead, the authorized transfers serve the ensure that sufficient value will be available for transactions and the card provider can use its own internal transaction data to make determinations about how much credit to extend to the user. Consequently, the user account can be set up faster, and the user's creditworthiness (and, e.g., the user's maximum limit) can be assessed more accurately.

In some embodiments, the card may be associated with a predetermined minimum amount defined for the predetermined time interval, where the predetermined threshold amount is more than the predetermined minimum amount. For example, a credit card may be associated with a minimum payment that must be made each month. The predetermined threshold amount transferred as part of the automatic transfer may be an amount greater than the minimum payment.

The card may further be associated with a maximum amount, and the threshold amount may be a predefined percentage of the maximum amount. For example, the transaction card may be assigned a credit limit, such that the total outstanding balance of the credit account cannot exceed the credit limit. The threshold amount may be a certain percentage of this maximum (e.g., 10%-75%, preferably 15%-25%, and more preferably about 30%).

In some embodiments, the threshold amount may be set to 100% of the amount deposited at the third party-institution in the interval defined by the user's pay period (e.g., 100% of the user's payroll from the employer may be direct-deposited into the primary value store).

In some embodiments, the predetermined time interval may be one week, two weeks, or one month. The predetermined time interval may be dependent upon a pay schedule of the user (e.g., if the user is paid monthly, the time interval may be one month).

In some embodiments, the primary value store may be a part of a pooled value store shared between a plurality of users, and the primary value store may be assigned a unique identifier configured to distinguish the user's primary value store from other primary value stores in the pooled value store.

In some embodiments, the primary value store may be under a control of the user and not the provider. In other words, the provider of the transaction card may not have the right to direct where or how the value in the primary value store is used. The user may maintain control over the value in the primary value store as though the primary value store were the user's personal account. The user may direct that the value in the primary value store be applied to the balance in the user's credit value store, transferred to another institution, or applied to a transaction with the provider of the transaction card and/or a third-party merchant.

For example, some embodiments may further involve: receiving a request from a merchant server to authorize a second transaction directly from the primary value store, determining that a sufficient value exists in the primary value store for the second transaction, and transmitting a second control signal to the merchant server, the control signal configured to cause a transfer of value corresponding to an amount of the transaction from the primary value store to the merchant server.

Exemplary embodiments relate to computer-implemented methods as discussed above, as well as non-transitory computer-readable mediums storing instructions for performing the methods, apparatuses configured to perform the methods, etc.

Other technical features will be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an exemplary computing architecture in accordance with one embodiment.

FIG. 2 illustrates an exemplary graphical user interface for administering a transaction card account in accordance with one embodiment.

FIG. 3 illustrates an exemplary graphical user interface for authorizing merchant purchases in accordance with one embodiment.

FIG. 4A is a flowchart describing exemplary logic suitable for determining if a transaction card is in an active or inactive state in accordance with one embodiment.

FIG. 4B is a flowchart describing exemplary logic suitable for approving or denying transfers and purchases associated with a transaction card in accordance with one embodiment.

FIG. 5 depicts an illustrative computer system architecture that may be used to practice exemplary embodiments described herein.

### DETAILED DESCRIPTION

Exemplary embodiments pertain to a computer architecture for supporting transactions through a transaction card, as well as methods, mediums, and interfaces for use with the architecture. According to one embodiment, a request to perform a transaction for an identified amount between a user and a merchant server may be received at a provider server associated with a transaction card issued to the user. The provider server may identify a card value store and a primary value store associated with the user. The provider server may determine whether the transaction card is in an active state based on an occurrence of an automatic transfer between an employer institution and the primary value store in a most-recent predetermined time interval. If the card is active, the provider server may transmit a control signal to the merchant server, the control signal configured to authorize the transaction on behalf of the user.

### A Note on Data Privacy

Some embodiments described herein make use of information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

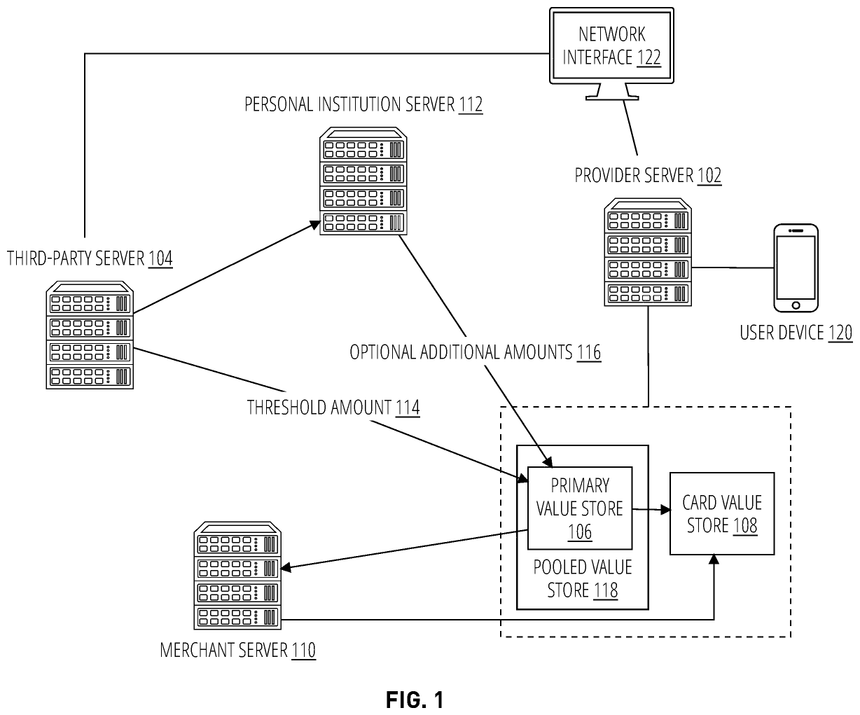

FIG. 1 depicts an exemplary computing architecture suitable for use with the embodiments described herein.

The architecture includes a provider server 102 associated with a provider of a transaction card to one or more users. The provider server 102 may maintain records of the users' accounts, authorize or deny transactions and transfers associated with the users, and otherwise administer use of the transaction card.

For example, the provider server 102 may maintain a database or similar set of records for each of the providers' users. The records may include a primary value store 106 and a card value store 108 for each user. The primary value store 106 may represent a store of value, such as a banking account that can be funded by the user. In some embodiments, each user's store of value may be pooled into a common pooled value store 118, and each user may be assigned an identifier (e.g., an account and/or routing number) that uniquely associates the user with the user's balance in the pooled value store 118. The card value store 108 may represent a balance in a credit account provided (or administered) by the provider for the benefit of the user.

The functionality of the provider server 102 may be split across multiple devices administered by a single or multiple entities. Third parties such as financial institutions may support the processing of transactions or may maintain accounts associated with the transaction card.

The provider server 102 may be in communication with a third-party server 104 over a network, such as the Internet. The third-party server 104 may be, for example, a server associated with a user's employer or the employer's financial institution. For example, the third-party server 104 may be a server that administers payroll on behalf of the employer.

A user may interact with the provider server 102 and/or the third-party server 104 to administer their accounts through a user device 120, such as a computer, mobile device, kiosk, etc. The provider server 102 and/or third-party server 104 may also be accessible through a network interface 122, such as a web site. In this way, the user may authorize (for example) the third-party server 104 to directly deposit a portion of the user's pay into the primary value store 106 managed by the provider server 102 at regular predetermined intervals. For instance, by providing the identifier for the user's primary value store 106 to the third-party server 104, the user can authorize the third-party server 104 to directly deposit funds (or other articles of value) into the primary value store 106 during each of the user's pay cycle.

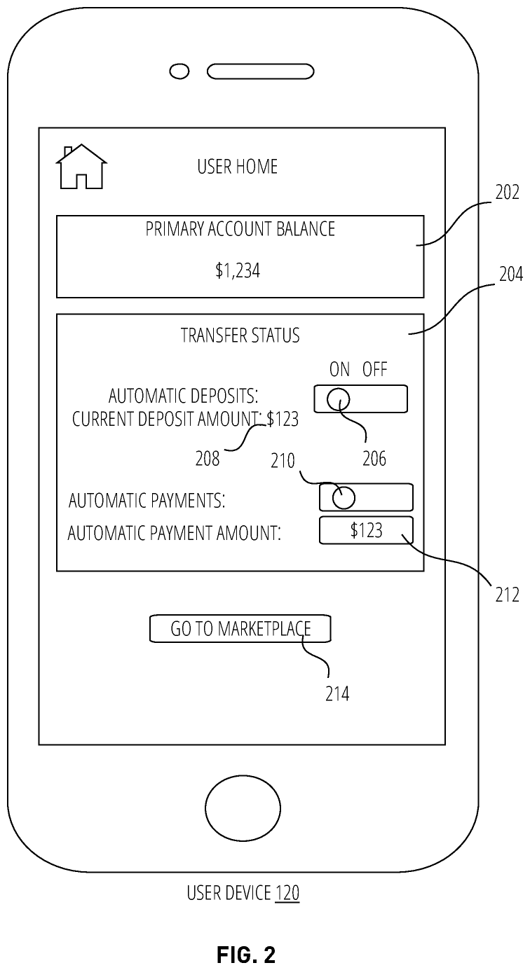

In some embodiments, the user is not required to authorize that the funds or articles of value be transferred during every predetermined interval; as depicted in FIG. 2, the user can activate and deactivate transfers as desired. However, the user's transaction card may be active or inactive depending on whether an automatic transfer was authorized in the most recent predetermined interval.

During each predetermined interval, the third-party server 104 may transfer a threshold amount 114 to the user's primary value store 106 maintained by the provider server 102. For instance, the threshold amount 114 may be a minimum amount required to keep the card in an active state. The threshold amount 114 may be, for example, a percentage of the maximum limit associated with the user's card value store 108 (e.g., the user's credit limit). Optionally, the user can authorize automatic or manual optional additional amounts 116 to be transferred from the third-party server 104 and/or a personal institution server 112 (e.g., a server associated with another user account, such as an account with the user's personal bank).

The transfer may be effected as follows. Initially, the provider server 102 may provide account information for the user (e.g., an account number or other identifier representing the primary value store 106) to the third party server 104. The information may include the provider's bank name, the user's account identifier, and the bank's routing number.

At each predetermined interval, the third-party server 104 initiates the payment process. The third-party server 104 may use the provided information to electronically transmit funds to the provider's identified bank. The payment may be submitted to the Automated Clearing House (ACH) network. The ACH network is a secure system used by financial institutions to process electronic transactions. The ACH network processes the transfer and sends it to the provider's bank. The receiving bank may receive the payment information and credit the provider's/user's account with the funds.

Once the funds are credited to the appropriate account, they may become available for use. The availability timeline can vary depending on the policies of the recipient's bank. In many cases, the funds are available on the same day the payment is received.

The user can use their transaction card to request that a transaction with a merchant be performed. For example, the user may request that the provider authorize a credit card purchase between the user and the merchant, or use the funds in the primary value store 106 to directly fund a purchase without relying on the credit provided by the provider. The transaction may be coordinated with a merchant server 110 associated with the merchant. If the user is relying on the card value store 108 to complete the transaction, the provider server 102 may authorize the transaction only if the transaction card is in the active state.

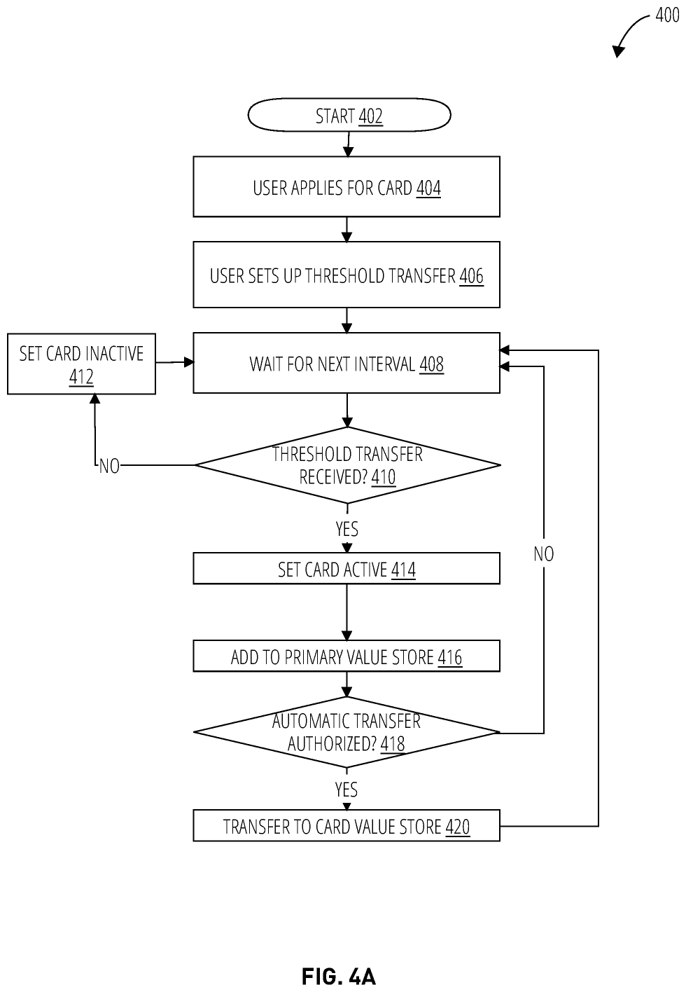

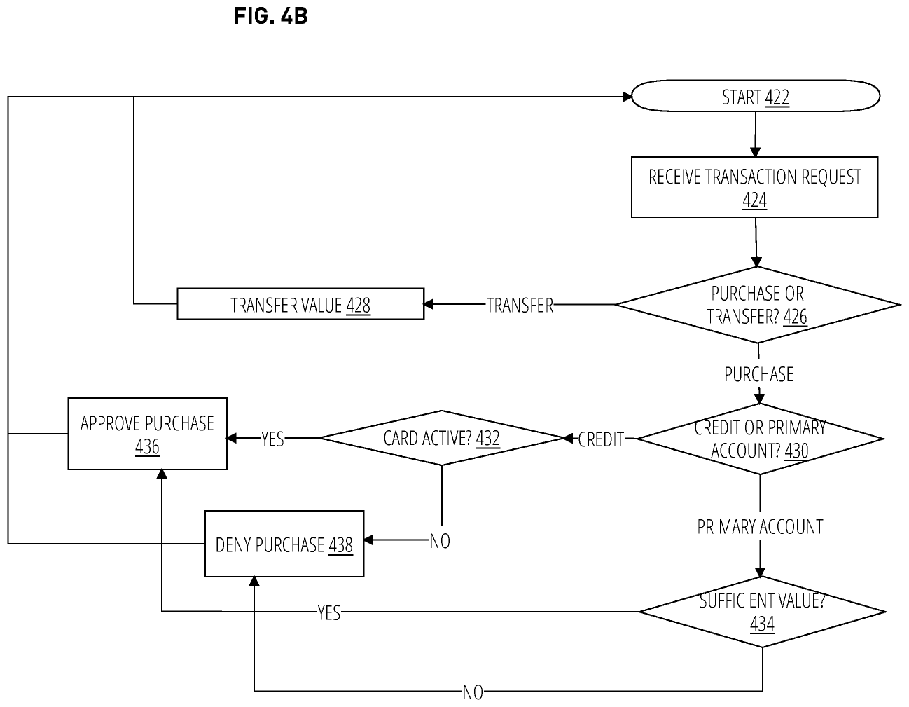

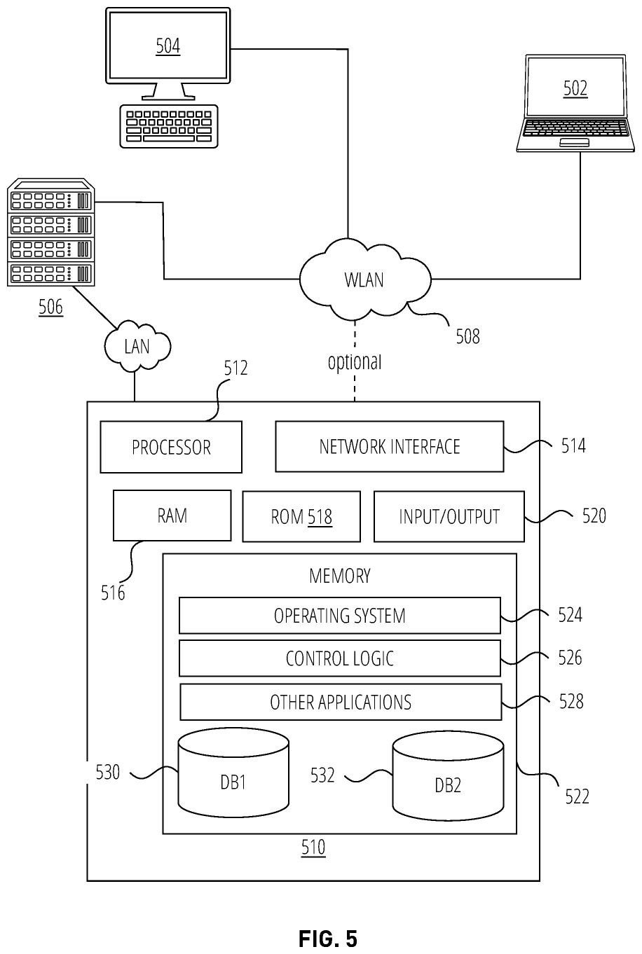

An exemplary computing device suitable for use as a provider server 102, third-party server 104, merchant server 110, personal institution server 112, or user device 120 is depicted in FIG. 5. The techniques described herein may be implemented as logic stored on the provider server 102 or distributed across the architecture; suitable logic is shown in FIG. 4A and FIG. 4B.

FIG. 2 illustrates an exemplary graphical user interface for administering a transaction card account in accordance with one embodiment. FIG. 2 is depicted in the context of a mobile user device 120, but one of ordinary skill in the art will understand that the interface may be displayed on other types of devices, or through a web page.

The interface includes a first portion with an account balance interface element 202. The account balance interface element 202 may indicate a current amount of value stored in the user's primary value store 106.

A second portion of the interface may display information and selectable options to configure the transfer of funds (or other articles of value) into and out of the primary value store 106. For example, as noted above a threshold amount 114 may be transferred from the third-party server 104 to the primary value store 106 at predetermined intervals. This portion of the interface may include a deposit authorization interface element 206 allowing the transfers to be toggled on or off by the user. Setting the deposit authorization interface element 206 to off may cause the third-party server 104 to refrain from withholding the threshold amount 114 and transferring it to the provider server 102. In some embodiments, stopping these transfers may require that the user interact with the third-party server 104, such as by submitting a request through their employer to refrain from transferring the threshold amount 114. If the transfers are stopped at the third-party server 104, then the second portion of the interface may be updated to reflect that the transfers have stopped (e.g., by placing the deposit authorization interface element 206 in the “off” position) as soon as the change is registered with the provider server 102. This may occur, for example, when the provider server 102 determines that an expected threshold amount 114 transfer did not occur, such as when the predetermined interval expires without receiving the threshold amount 114. In some embodiments, the card may be de-activated before an expected transfer fails to occur. For example, if the user de-activates withholding from the third-party server 104 so that the transfer to the provider server 102 will not occur at some future date (such as by disconnecting payroll payments from the third-party server 104).

The second portion of the interface may also include a deposit amount indicator 208 that shows the amount of the threshold amount 114 authorized at each predetermined interval. In some embodiments, the second portion of the interface may include a selector allowing the length of the predetermined interval to be adjusted (e.g., to daily, weekly, biweekly, monthly, etc.).

The second portion of the interface may further include a payment authorization interface element 210 that authorizes the provider server 102 to automatically transfer a certain amount of value from the primary value store 106 to the card value store 108 at specified intervals or on specified dates (e.g., when a payment is due on the user's credit account). In some embodiments, the specified intervals may be at shorter intervals than when a payment is due, such as daily or weekly, in order to reduce a balance in the card value store 108; a user may also make manual one-time payments using the interface. The automatic or manual payments may be for the same amount each time, or may be for variable amounts. The user may be able to freely toggle the payment authorization interface element 210 to authorize or de-authorize transfers as desired. A payment amount indicator 212 may indicate the amount of the automatic payment currently authorized, and by adjusting the amount in the payment amount indicator 212, the user may change the amount that will be automatically sent from the primary value store 106 to the card value store 108.

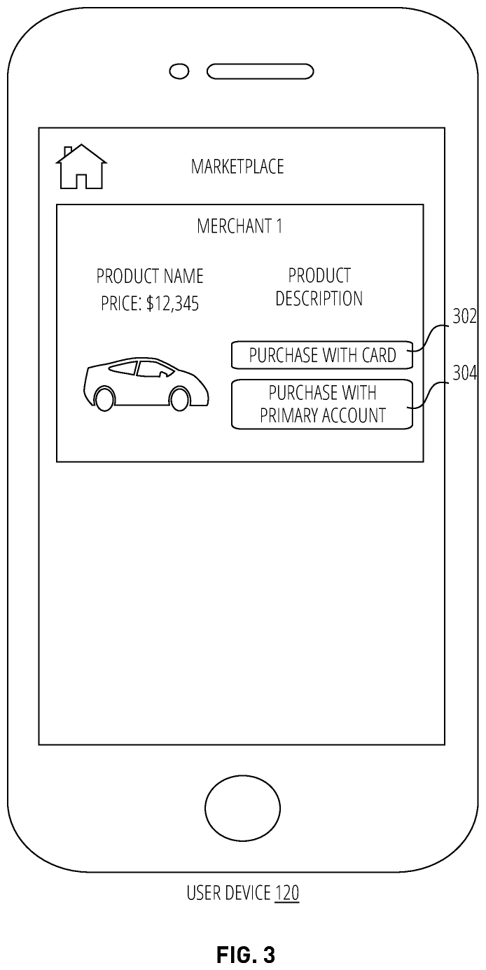

The interface may include other elements, such as an option to transfer an amount of value from the primary value store 106 to another account, such as an account of the user administered by the personal institution server 112. Furthermore, the user may use funds in the primary value store 106 to directly pay for transactions with merchants without relying on credit capabilities provided by the provider. To that end, a marketplace selector 214 allows the user to view a marketplace, such as the one depicted in FIG. 3.

FIG. 3 illustrates an exemplary graphical user interface for authorizing merchant purchases in accordance with one embodiment. In this example, the marketplace features a number of merchants, each of which may offer one or more products or services. When a user identifies a product or service that they wish to purchase, they can request that the purchase be funded through either or both of the primary value store 106 or the card value store 108. For example, a credit purchase element 302 allows the user to request that the product or service be purchased through the card value store 108, in which case the provider server 102 determines whether the purchase is authorized (see FIG. 4B) and approves or denies the purchase accordingly. Similarly, a primary account purchase element 304 allows the purchase to be directly funded from the primary value store 106, in which case the provider server 102 need not determine whether the card is active or inactive, but only needs to determine whether a sufficient reserve of value exists in the primary value store 106 to fund the purchase.

In some embodiments, additional value may be added to the primary value store 106 by the provider or a third party (for example, as a reward or incentive).

FIG. 4A is a flowchart depicting exemplary logic for performing a computer-implemented method according to an exemplary embodiment. The logic may be embodied as instructions stored on a computer-readable medium configured to be executed by a processor. The logic may be implemented by a suitable computing system configured to perform the actions described below.

Processing may begin at start block 402, which may be performed in response to the provider server 102 starting up.

In block 404, the provider server 102 may receive a request in which a user applies for transaction card. The request may be submitted via a web page, mobile application associated with the provider, or another source. The request may include (or the provider server 102 may solicit) user demographic information (such as a user name, address, phone number, personal identifier such as a social security number, etc.). The provider server 102 may evaluate and approve or deny the request using a variety of techniques (e.g., using a credit score, proprietary algorithms that examine data sources that do not require the use of a credit score, etc.). If approved, the user may be offered an extension of credit in the form of a card value store 108 designated to the user.

When the card value store 108 is created, a corresponding primary value store 106 may also be created for the user in a similar manner. A transaction card linked to the card value store 108 may be sent to the user, but may initially be created in an inactive state. As part of setting up the user's account, at block 406 the user may be prompted to set up an automatic transfer of the threshold amount 114 from the third-party server 104. For example, the user may be prompted to set up a direct deposit payment from their payroll with their employer. In some cases, the user may log into the third-party server 104 directly through a network interface 122, while in others the user may need to go through an intermediary (such as their employer) in order to direct the automatic transfer of the threshold amount 114 to occur. The user may be provided with a minimum amount of the threshold amount 114 required to keep the card active (although the user may direct that more than the minimum amount be automatically transferred, if desired). When the first automatic transfer occurs (or the provider server 102 is provided with an indication that automatic transfers have been authorized by the third-party server 104), then the card may be set to an active status and the user may be authorized to make purchases using the card value store 108.

In some embodiments, the card value store 108 is not created, and a physical card is not sent to the user, until the provider receives the payroll payment 114 from the third party server 104 (or an indication that the payroll payment 114 has been authorized to be sent from third party server 104 in the future).

The automatic transfer may be configured to occur on predetermined intervals (e.g., based on a length or frequency of the user's pay periods). As each predetermined interval elapses, the third-party server 104 may transfer the threshold amount 114 to the primary value store 106, if authorization still exists to do so (e.g, if the user has not revoked a previous authorization). The threshold amount 114 may be augmented with optional additional amounts 116, if such transfers have been set up by the user with the third-party server 104 or personal institution server 112.

In block 408, the provider server 102 may wait for the next interval to elapse. In decision block 410, the provider server 102 may determine if the threshold amount 114 has been received for the current interval. If not (e.g., a previous authorization has been revoked), then in block 412 the card may be set to an inactive state. Alternatively or in addition, the provider server 102 may set the card to an inactive state if it receives an indication that future transfers have been deactivated or turned off, in this way, the card may be deactivated before the provider server 102 fails to receive the next transfer.

If the automatic transfer was received (or the provider server 102 receives an indication that the automatic transfer has been authorized), then in block 414 the card may be set as active. In block 416, the amount added in the automatic transfer may be added to the primary value store 106 for the user.

In decision block 418, the provider server 102 determines if an automatic transfer from the primary value store 106 to the card value store 108 has been authorized. For example, the user may authorize that the value in the primary value store 106 be used to pay down the balance in the card value store 108 at second predetermined intervals (which may be the same or different from the predetermined intervals used to transfer the threshold amount 114). If so, then at block 420, the provider server 102 may transfer the amount authorized by the user from the primary value store 106 to the card value store 108. This may occur once per second predetermined interval (e.g., on the user's payment due date associated with their card value store 108), or more frequently (e.g., daily), depending on how the user's account is configured. After processing concludes at block 420 (or if automatic transfers are not authorized at decision block 418, processing may return to block 408 and the provider server 102 may wait until the predetermined interval elapses again.

FIG. 4A is a flowchart depicting exemplary logic for performing a computer-implemented method according to an exemplary embodiment—namely, logic configured to perform a requested transaction in response to receiving a transaction request. The logic may be embodied as instructions stored on a computer-readable medium configured to be executed by a processor. The logic may be implemented by a suitable computing system configured to perform the actions described below.

Processing begins at start block 422, which may be executed in response to the provider server 102 starting up.

In block 424, the provider server 102 may receive a transaction request from a merchant server 110, the user device 120, the personal institution server 112, or another source. The transaction request may be a request to perform one of a variety of different types of available transactions; for example, at decision block 426 the provider server 102 may determine whether the transaction involves a request to make a purchase or to transfer funds from the primary value store 106 to another location.

If the request is to transfer funds, then processing may proceed to block 428. Here, the system determines whether a sufficient amount of value exists in the primary value store 106 to accommodate the request. If so, the request is approved and the value is transferred. If not, the request may be denied, or performed subject to conditions (such as an agreement to repay the overage).

It is noted that, in some embodiments, the provider associated with the provider server 102 may not have the right to control how the value in the primary value store 106 is used, which is owned by and under the control of the user. For example, if a user requests that a transfer from the primary value store 106 be carried out while the user maintains a balance in the card value store 108 (even a past-due balance), the provider server 102 may carry out the transfer request as directed by the user.

If the request is to make a purchase, then processing proceeds to decision block 430 where the 102 determines whether the purchase is a credit purchase (funded through the card value store 108) or non-credit purchase (funded through the primary value store 106). This may be dependent, for instance, on whether the transaction request originated with the credit purchase element 302 or primary account purchase element 304 in the marketplace interface.

If the purchase is a credit purchase, processing may proceed to decision block 432 and the provider server 102 may determine whether the transaction card is in an active or inactive state (see FIG. 4A). If inactive, processing may proceed to block 438 and the purchase may be denied. In this case, a negative command signal may be sent to the merchant or other entity that originated the transaction request, the negative command signal configured to reject the transaction request and cause the transaction not to be carried out. If active (and, in some embodiments, if the transaction will not cause the user to exceed their maximum limit), processing may proceed to block 436 and the purchase may be approved. In this case, a positive command signal may be sent to the merchant or other entity that originated the transaction request, the positive command signal configured to approve the transaction request and cause the transaction to be carried out. Meanwhile, the amount of the transaction may be deducted from the user's card value store 108.

After the transaction is processed, the user may have authorized automatic payments from the primary value store 106 to be applied to cover the costs of outstanding transactions. At predetermined intervals (which may be adjusted by the user through the user interface), the system may automatically deduct the designated amount from the primary value store 106 and correspondingly adjust the card value store 108 to reflect the payments.

FIG. 5 illustrates one example of a system architecture and data processing device that may be used to implement one or more illustrative aspects described herein in a standalone and/or networked environment. Various network nodes, such as the data server 510, web server 506, computer 504, and laptop 502 may be interconnected via a wide area network 508 (WAN), such as the internet. Other networks may also or alternatively be used, including private intranets, corporate networks, LANs, metropolitan area networks (MANs) wireless networks, personal networks (PANs), and the like. Network 508 is for illustration purposes and may be replaced with fewer or additional computer networks. A local area network (LAN) may have one or more of any known LAN topology and may use one or more of a variety of different protocols, such as ethernet. Devices data server 510, web server 506, computer 504, laptop 502 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 510, web server 506, and client computer 504, laptop 502. Data server 510 provides overall access, control and administration of databases and control software for performing one or more illustrative aspects described herein. Data server 510 may be connected to web server 506 through which users interact with and obtain data as requested. Alternatively, data server 510 may act as a web server itself and be directly connected to the internet. Data server 510 may be connected to web server 506 through the network 508 (e.g., the internet), via direct or indirect connection, or via some other network. Users may interact with the data server 510 using remote computer 504, laptop 502, e.g., using a web browser to connect to the data server 510 via one or more externally exposed web sites hosted by web server 506. Client computer 504, laptop 502 may be used in concert with data server 510 to access data stored therein, or may be used for other purposes. For example, from client computer 504, a user may access web server 506 using an internet browser, as is known in the art, or by executing a software application that communicates with web server 506 and/or data server 510 over a computer network (such as the internet).

Servers and applications may be combined on the same physical machines, and retain separate virtual or logical addresses, or may reside on separate physical machines. FIG. 5 illustrates just one example of a network architecture that may be used, and those of skill in the art will appreciate that the specific network architecture and data processing devices used may vary, and are secondary to the functionality that they provide, as further described herein. For example, services provided by web server 506 and data server 510 may be combined on a single server.

Each component data server 510, web server 506, computer 504, laptop 502 may be any type of known computer, server, or data processing device. Data server 510, e.g., may include a processor 512 controlling overall operation of the data server 510. Data server 510 may further include RAM 516, ROM 518, network interface 514, input/output interfaces 520 (e.g., keyboard, mouse, display, printer, etc.), and memory 522. Input/output interfaces 520 may include a variety of interface units and drives for reading, writing, displaying, and/or printing data or files. Memory 522 may further store operating system software 524 for controlling overall operation of the data server 510, control logic 526 for instructing data server 510 to perform aspects described herein, and other application software 528 providing secondary, support, and/or other functionality which may or may not be used in conjunction with aspects described herein. The control logic may also be referred to herein as the data server software control logic 526. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 532 and a second database 530. In some embodiments, the first database may include the second database (e.g., as a separate table, report, etc.). That is, the information can be stored in a single database, or separated into different logical, virtual, or physical databases, depending on system design. Web server 506, computer 504, laptop 502 may have similar or different architecture as described with respect to data server 510. Those of skill in the art will appreciate that the functionality of data server 510 (or web server 506, computer 504, laptop 502) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method comprising:
receiving, at a provider server associated with a provider of a transaction card to a user, a request to perform a transaction for an identified amount between the user and a merchant server;
identifying, at the provider server, a card value store associated with the transaction card of the user, the card value store being associated with a primary value store distinct from the card value store and maintained by the provider server;
determining, at the provider server, whether the transaction card of the user is in an active state or an inactive state, wherein:
the transaction card is configured to be in an active state if:
an automatic transfer of a predetermined threshold amount occurred in a most-recent predetermined time interval, the automatic transfer causing the predetermined threshold amount to be transferred to the primary value store from a third-party institution associated with the user, or
the provider server receives an indication from the third-party institution that the automatic transfer has been authorized to occur in the future; and
transmitting a control signal to the merchant server, the control signal configured to authorize the transaction on behalf of the user when the transaction card is in the active state or deny the transaction on behalf of the user when the transaction card is in the inactive state.

2. The computer-implemented method of claim 1, wherein the card is associated with a predetermined minimum amount defined for the predetermined time interval, and the threshold amount is more than the predetermined minimum amount.

3. The computer-implemented method of claim 2, wherein the predetermined time interval is daily, weekly, biweekly, or monthly.

4. The computer-implemented method of claim 1, wherein the transaction card is associated with a maximum amount, and the threshold amount is a predefined percentage of the maximum amount.

5. The computer-implemented method of claim 1, wherein the primary value store is a part of a pooled value store shared between a plurality of users, and the primary value store is assigned a unique identifier configured to distinguish the user's primary value store from other primary value stores in the pooled value store.

6. The computer-implemented method of claim 1, wherein the primary value store is under a control of the user and not the provider.

7. The computer-implemented method of claim 1, further comprising:
receiving a request from a merchant server to authorize a second transaction directly from the primary value store;
determining that a sufficient value exists in the primary value store for the second transaction; and
transmitting a second control signal to the merchant server, the control signal configured to cause a transfer of value corresponding to an amount of the transaction from the primary value store to the merchant server.

8. A non-transitory computer-readable storage medium, the computer-readable storage medium including instructions that when executed by a computer, cause the computer to:
receive, at a provider server associated with a provider of a transaction card to a user, a request to perform a transaction for an identified amount between the user and a merchant server;
identify, at the provider server, a card value store associated with the transaction card of the user, the card value store being associated with a primary value store distinct from the card value store and maintained by the provider server;
determine, at the provider server, whether the transaction card of the user is in an active state, wherein:
the transaction card is configured to be in an active state if:
an automatic transfer of a predetermined threshold amount occurred in a most-recent predetermined time interval, the automatic transfer causing the predetermined threshold amount to be transferred to the primary value store from an employer institution associated with the user, or
the provider server receives an indication from the third-party institution that the automatic transfer has been authorized to occur in the future, and
the transaction card is configured to be in an inactive state if the automatic transfer did not occur in the most-recent predetermined time interval or if the provider server receives a second indication from the third-party institution that the automatic transfer has not been authorized to occur in the future; and
transmit a control signal to the merchant server, the control signal configured to authorize the transaction on behalf of the user when the transaction card is in the active state or deny the transaction on behalf of the user when the transaction card is in the inactive state.

9. The computer-readable storage medium of claim 8, wherein the card is associated with a predetermined minimum amount defined for the predetermined time interval, and the threshold amount is more than the predetermined minimum amount.

10. The computer-readable storage medium of claim 9, wherein the predetermined time interval is daily, weekly, biweekly, or monthly.

11. The computer-readable storage medium of claim 8, wherein the card is associated with a maximum amount, and the threshold amount is a predefined percentage of the maximum amount.

12. The computer-readable storage medium of claim 8, wherein the primary value store is a part of a pooled value store shared between a plurality of users, and the primary value store is assigned a unique identifier configured to distinguish the user's primary value store from other primary value stores in the pooled value store.

13. The computer-readable storage medium of claim 8, wherein the primary value store is under a control of the user and not the provider.

14. The computer-readable storage medium of claim 8, wherein the instructions further configure the computer to:
receive a request from a merchant server to authorize a second transaction directly from the primary value store;
determine that a sufficient value exists in the primary value store for the second transaction; and
transmit a second control signal to the merchant server, the control signal configured to cause a transfer of value corresponding to an amount of the transaction from the primary value store to the merchant server.

15. A computing apparatus comprising:
a processor; and
a memory storing instructions that, when executed by the processor, configure the apparatus to:
receive, at a provider server associated with a provider of a transaction card to a user, a request to perform a transaction for an identified amount between the user and a merchant server;
identify, at the provider server, a card value store associated with the transaction card of the user, the card value store being associated with a primary value store distinct from the card value store and maintained by the provider server;
determine, at the provider server, whether the transaction card of the user is in an active state, wherein:
the transaction card is configured to be in an active state if:
an automatic transfer of a predetermined threshold amount occurred in a most-recent predetermined time interval, the automatic transfer cause the predetermined threshold amount to be transferred to the primary value store from an employer institution associated with the user, or
the provider server receives an indication from the third-party institution that the automatic transfer has been authorized to occur in the future, and
the transaction card is configured to be in an inactive state if the automatic transfer did not occur in the most-recent predetermined time interval or if the provider server receives a second indication from the third-party institution that the automatic transfer has not been authorized to occur in the future; and
transmit a control signal to the merchant server, the control signal configured to authorize the transaction on behalf of the user when the transaction card is in the active state or deny the transaction on behalf of the user when the transaction card is in the inactive state.

16. The computing apparatus of claim 15, wherein the card is associated with a predetermined minimum amount defined for the predetermined time interval, and the threshold amount is more than the predetermined minimum amount.

17. The computing apparatus of claim 16, wherein the predetermined time interval is daily, weekly, biweekly, or monthly.

18. The computing apparatus of claim 15, wherein the card is associated with a maximum amount, and the threshold amount is a predefined percentage of the maximum amount.

19. The computing apparatus of claim 15, wherein the primary value store is a part of a pooled value store shared between a plurality of users, and the primary value store is assigned a unique identifier configured to distinguish the user's primary value store from other primary value stores in the pooled value store.

20. The computing apparatus of claim 15, wherein the primary value store is under a control of the user and not the provider.
